(19) United States
(12) Patent Application Publication
(10) Pub. No.: US 2007/0238486 A1
(43) Pub. Date: Oct. 11, 2007

(54) TELEPHONE WITH ABILITY TO COMMUNICATE THROUGH VARIOUS NETWORKS

(75) Inventors: Cheng-Shing Lai, Taipei County (TW); Guo-Qing Tang, Nanjing (CN); Jian Shen, Nanjing (CN)

Correspondence Address: WPAT, PC, 7225 BEVERLY ST., ANNANDALE, VA, 22003, US

(73) Assignee: INVENTEC APPLIANCES CORP., Taipei County (TW)

(21) Appl. No.: 11/689,714

(22) Filed: Mar. 22, 2007

(30) Foreign Application Priority Data
Apr. 7, 2006 (TW) 095112330

(51) Int. Cl. H04B 1/38

(52) U.S. Cl. 455/558

(57) ABSTRACT

The present invention relates to a telephone, which is adapted to a public switched telephone network (PSTN) and is capable of making a call though various communication networks. As the aforesaid PSTN telephone is configured with a plurality of wireless interface modules (WIM) that one of which is activated with reference to a subscriber identity module (SIM) card being installed into the PSTN telephone by a user, the PSTN telephone is able to provide a wireless connection through the activated WIM supporting the SIM card for enabling the user to make a phone call. Therefore, the user can make a phone call simply by inserting the SIM card into the aforesaid PSTN telephone for enabling the same to access data stored in the SIM card.

### FIELD OF THE INVENTION

The present invention relates to a telephone, and more particularly, to a telephone, adapted to a public switched telephone network (PSTN) while being enabled to be capable of making a call though various communication networks.

### BACKGROUND OF THE INVENTION

With the prevalent of radio communication among modern people at the present day, almost everyone will purchase a cellular phone for the convenience of communicating with relatives and friends. As cellular phones are accustomed to be carries by most people all day long and everywhere, one might preferred to register one's frequent-used phone numbers on a subscriber identity module (SIM) card of his/her cellular phone. For example, when one's cellular phone is malfunctioned or runs out of battery, the SIM card used in the cellular phone is usually perfectly functional that can be inserted into another cellular phone supporting the SIM card for enabling the owner of the SIM card to access and use data stored therein and thus making a call. However, when emergency strikes, it is hard to find another cellular phone just in time for accessing a phone number stored in one's SIM card to make a call, moreover, since usually it is not possible for a user to remember all the phone numbers stored in his/her SIM card, public phone is not an option as the required phone number is stored in his/her SIM card that has no way of accessing.

Nowadays, public phones, no matter they are conventional coin payphones or card payphones, are available at almost every public place that are devices capable of receiving/transmitting vocal data in an analog manner through a Public Switched Telephone Network (PSTN). Those conventional public phones no only restrict a user to pay for a phone call in advance by coins or by a specific IC phone card, the user is restricted and can only use the PSTN for communication. It is noted that the communication tariff of a PSTN system is usually much higher than that of a cellular phone service provider. Thus, the communication cost can be greatly reduced when a phone call of a public phone can be charged according to the communication tariff of cellular phone service provider.

From the above description, a user, being forced to use conventional public phone, for example, when his/her cellular is malfunctioned or out of battery, can only choose to make a call through the PSTN while paying the call by coins or telephone card. Moreover, the user will have no way to access phone numbers stored in his/her SIM card by the public phone.

Therefore, it is in need of a telephone with ability to communicate through various networks.

### SUMMARY OF THE INVENTION

In view of the disadvantages of prior art, the primary object of the present invention is to provide a telephone with ability to communicate through various networks, which is substantially a telephone not only equipped with communication abilities the same as those of a public phone or a private phone, but also having ability to access data stored in a specific user identity card of a user and to transmit/receive vocal data through a mobile communication network supporting the SIM card.

Another object of the invention is to provide a means for enabling a user to have access to data stored in a specific user identity card of an unusable cellular phone and thus use the SIM card for making a call through a communication network supporting the specific user identity card.

Yet, it is another object of the invention to provide a means for enabling a user to select a specific user identity card as a charging media while making a call thereby and thus freeing the user from paying the call by coins or a specific IC telephone card as that used in a conventional public phone, so that a cheaper tariff can be selected for paying the call and thus the communication expense can be reduced.

The present invention provides a telephone, adapted to a public switched telephone network (PSTN) while being enabled to make a call though various communication networks, which is comprised of: a connecting unit, coupled to a specific user identity card; a wireless transmission unit, comprising at least a wireless interface module, being used for transmitting/receiving a message; a signal switching unit, coupled to the connecting unit and the wireless transmission unit, capable of selected a wireless interface module with respect to the specific user identity card while establishing a connection between the selected wireless interface module and the specific user identity card; and a central processing unit, coupled to the wireless transmission unit and the signal switching unit for enabling the same to control the two units.

Preferably, the connecting unit can be constructed as a slot for receiving the specific user identity card while having a plurality of circuit contacts formed therein for connecting to the specific user identity card. Moreover, the specific user identity can be a subscriber identity module (SIM) card, a personal identity module (PIM) card, or a user identity module (UIM) card. In a preferred embodiment, the wireless transmission unit further comprises: a Global System for Mobile Communication (GSM) wireless interface module, a Personal Handyphone System (PHS) wireless interface module, and a Code Division Multiple Access (CDMA) wireless interface module. In addition, the message can be a vocal data, a data of Short Messaging Service (SMS) protocol, a data of Enhanced Message Service (EMS) protocol, or a data of Multimedia Message Service (MMS) protocol. Furthermore, the signal switching unit can be an integrated circuit (IC) chip capable of establishing a connection between the specific user identity card and the wireless interface module supporting the card.

In addition, the telephone with ability to communicate through various networks is further comprised of: a display, for displaying data stored in the specific user identity card; a memory, used for storing the message; and a PSTN interface module, for enabling the telephone to transmit/receive the message through the public switched telephone network.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram illustrating the network structure of a PSTN phone with ability to communicate through various networks according to a preferred embodiment of the invention.

FIG. 2 is a block functional diagram of a PSTN phone according to a preferred embodiment of the invention.

FIG. 3 is a schematic diagram depicting a wireless communication section of a PSTN phone according to a preferred embodiment of the invention.

FIG. 4 is a flow chart illustrating steps for operating a PSTN phone of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

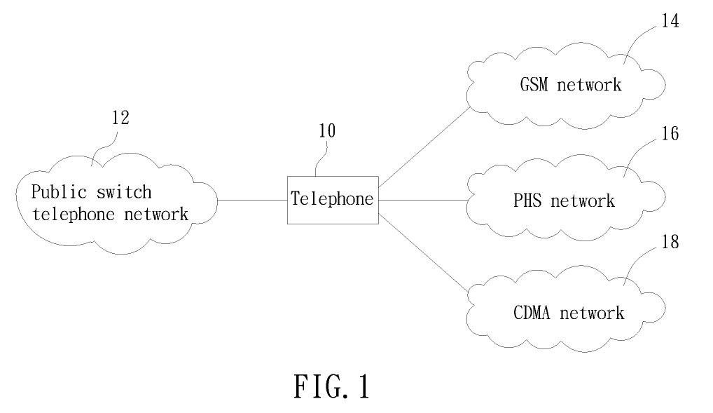

Please refer to FIG. 1, which is a schematic diagram illustrating the network structure of a PSTN phone with ability to communicate through various networks according to a preferred embodiment of the invention. Operationally, the telephone 10 of FIG. 1 is able to make a call through a public switched telephone network (PSTN) 12 without having a specific user identity card inserted therein, and also is able to select a wireless communication network compatible to the specific user identity card and thus make a call through the selected network while the specific user identity card is inserted therein. For instance, if the specific user identity card is a Subscriber Identity Module (SIM) card that is being inserted in the aforesaid telephone 10, a Global System for Mobile Communication (GSM) communication network 14 is selected for placing the call; if the specific user identity card is a Personal Identity Module (PIM) card that is being inserted in the aforesaid telephone 10, a Personal Handyphone System (PHS) communication network 16 is selected for placing the call; and if the specific user identity card is a User Identity Module (UIM) card that is being inserted in the aforesaid telephone 10, a Code Division Multiple Access (CDMA) communication network 18 is selected for placing the call. Therefore, comparing to those conventional public phones and private phones, the aforesaid telephone 10 can provide a means for enabling a user to select a specific user identity card as a charging media while making a call thereby and thus freeing the user from paying the call by coins or a specific IC telephone card as that used in a conventional public phone, so that a cheaper tariff can be selected for paying the call and thus the communication expense can be reduced.

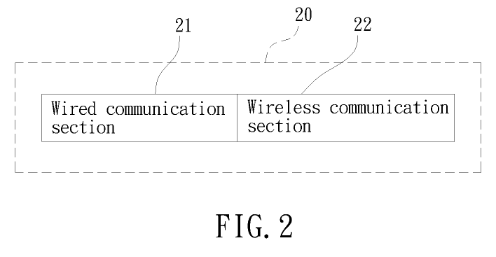

Please refer to FIG. 2, which is a block functional diagram of a PSTN phone according to a preferred embodiment of the invention. In FIG. 2, the telephone 20 is adapted to a public switched telephone network (PSTN) while being enabled to make a call though various communication networks, which is comprised of: a wired communication section 21 and a wireless communication section 22. When the telephone is having no user identity card inserted therein, the wired communication section is enabled for a user to place a call similar to those conventional public phone and private phones, that is, vocal data of the call is being transmitted/received through the public switched telephone network by at least a PSTN interface module (not shown) embedded in the wired communication section 21 and charged by coin collecting or through a IC phone card fitted therein. On the other hand, when a user identity card is inserted in the telephone 20, the wireless communication section 22 is enabled so as to enable a user to place a call through a wireless communication network, such as a GSM network, a PHS network, and a CDMA network, etc., while the wireless communication network is selected according to the inserted user identity card and thus enables the call to be charged by the fee-charging schedule and apparatus of the selected wireless communication network. In one aspect, the wired and the wireless communication section 21, 22 are independent to each other, that is, when a call is being placed through the network supporting the user identity card by the wireless communication section 22, it is possible to make/receive another call through the wired communication section 21.

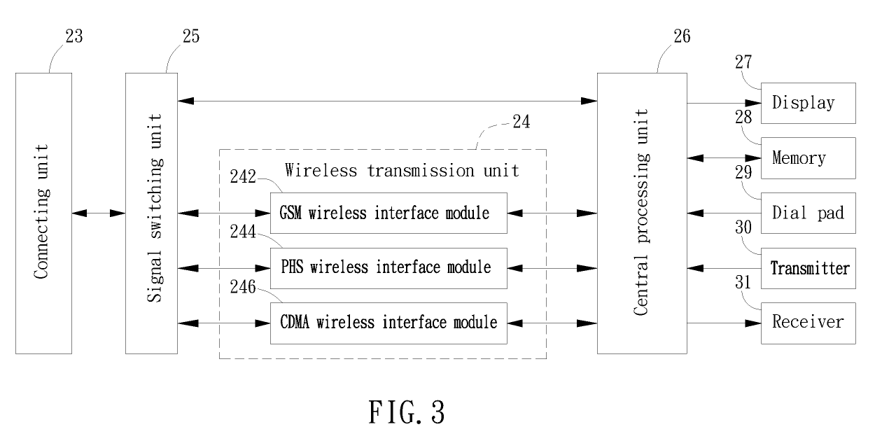

Please refer to FIG. 3, which is a schematic diagram depicting a wireless communication section of a PSTN phone according to one embodiment of the invention. In FIG. 3, the wireless communication section 22 comprises: a connecting unit 23, coupled to a specific user identity card (not shown); a wireless transmission unit 24, further comprising a GSM wireless interface module 242, PHS wireless interface module 244 and a CDMA wireless interface module 246, being used for transmitting/receiving a message through one of the aforesaid wireless interface modules selected with respect to the specific user identity card; a signal switching unit 25, coupled to the connecting unit 23 and the wireless transmission unit 24, capable of selected one of the aforesaid wireless interface modules of the wireless transmission unit 24 with respect to the specific user identity card while establishing a connection between the selected wireless interface module and the specific user identity card; and a central processing unit 26, coupled to the wireless transmission unit 24 and the signal switching unit 25 for enabling the same to control the two units; wherein, the specific user identity can be a subscriber identity module (SIM) card, a personal identity module (PIM) card, or a user identity module (UIM) card; and the message can be a vocal data, a data of Short Messaging Service (SMS) protocol, a data of Enhanced Message Service (EMS) protocol, or a data of Multimedia Message Service (MMS) protocol. In one embodiment, when the user identity card is a SIM card, the signal switching module 25 will establish the connection between the SIM card and the GSM wireless interface module 242; and when the user identity card is a PIM card, the signal switching module 25 will establish the connection between the PIM card and the PHS wireless interface module 244; and when the user identity card is an UIM card, the signal switching module 25 will establish the connection between the UIM card and the CDMA wireless interface module 246.

Wherein, the connecting unit 23 can be constructed as a slot for receiving the specific user identity card while having a plurality of circuit contacts formed therein for connecting to the specific user identity card. Operationally, when the type of the user identity card is detected and identified by the signal switching unit 25 and the central processing unit 26, voltages suitable for the user identity card and relating control signals are provided to the user identity card for enabling the same to function properly. In one aspect, the signal switching unit 24 can be an integrated circuit (IC) chip capable of establishing a connection between the specific user identity card and the wireless interface module supporting the card. It is known that the aforesaid slot and IC chip are only one embodiment used for illustration and are not limited thereby.

Moreover, the wireless communication section 22 is comprised a display 27 and a memory 28, in which the display is capable of displaying data stored in the specific user identity card, such as a phone book; and the memory 28 is capable of storing messages received by the telephone. In one aspect, the wireless communication section 22 further comprises a dial pad 29, a transmitter 30 and a receiver 31; wherein the dial pad 29 can be a standard dial pad defined by CCITT; the transmitter 30 can be a microphone; and the receiver 31 can be a speaker. It is noted that the display 27, the dial pad 29, the transmitter 30, the receiver 31 of the wireless communication section 22 can be shared with the wired communication section 21.

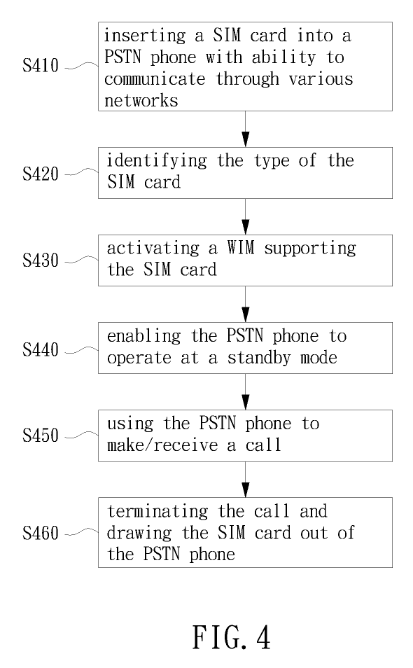

Please refer to FIG. 4, which is a flow chart illustrating steps for operating a PSTN phone of the invention. The flow starts at step S410. In step S410, a user identity card is being inserted into a telephone of the invention by a user. Step S420, the type of the user identity card is detected and identified by the telephone. Step S430, a wireless interface module (WIM) supporting the user identity card is activated. Step S440, the telephone is enabled to enter a standby mode. Step S450, the user uses the telephone to make/receive a call. Step S460, the user identity card is being drawn out of the telephone after the call is terminated. In addition, when the telephone enters its standby mode as that shown in step S440, the user can first inspect data stored in the user identity card, and then choose to make the call through PSTN paid by coins or telephone card, or through the WIM supporting the user identity card.

To sum up, the telephone provided in the invention is an improved telephone for replacing those conventional public phones and private phones, since it not only is capable of making a call through PSTN while having no SIM card inserted therein, but also has ability to access data stored in the SIM card and to transmit/receive vocal data through a mobile communication network supporting the SIM card.

While the embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A telephone, adapted to a public switched telephone network (PSTN) while being enabled to make a call though various communication networks, comprising:
a connecting unit, coupled to a specific user identity card;
a wireless transmission unit, further comprising at least a wireless interface module, being used for transmitting/receiving a message;
a signal switching unit, coupled to the connecting unit and the wireless transmission unit, capable of selected a wireless interface module with respect to the specific user identity card while establishing a connection between the selected wireless interface module and the specific user identity card; and
a central processing unit, coupled to the wireless transmission unit and the signal switching unit, capable of controlling the wireless transmission unit and the signal switching unit.

2. The telephone with ability to communicate through various networks of claim 1, wherein the connecting unit is constructed as a slot for receiving the specific user identity card while having a plurality of circuit contacts formed therein for connecting to the specific user identity card.

3. The telephone with ability to communicate through various networks of claim 1, wherein specific user identity card is a Subscriber Identity Module (SIM) card.

4. The telephone with ability to communicate through various networks of claim 1, wherein the specific user identity card is a Personal Identity Module (PIM) card.

5. The telephone with ability to communicate through various networks of claim 1, wherein the specific user identity card is a User Identity Module (UIM) card.

6. The telephone with ability to communicate through various networks of claim 1, wherein the wireless transmission unit further comprises a Global System for Mobile Communication (GSM) wireless interface module.

7. The telephone with ability to communicate through various networks of claim 1, wherein the wireless transmission unit further comprises a Personal Handyphone System (PHS) wireless interface module.

8. The telephone with ability to communicate through various networks of claim 1, wherein the wireless transmission unit further comprises a Code Division Multiple Access (CDMA) wireless interface module.

9. The telephone with ability to communicate through various networks of claim 1, wherein the message is a vocal data.

10. The telephone with ability to communicate through various networks of claim 1, wherein the message is a data of Short Messaging Service (SMS) protocol.

11. The telephone with ability to communicate through various networks of claim 1, wherein the message is a data of Enhanced Message Service (EMS) protocol.

12. The telephone with ability to communicate through various networks of claim 1, wherein the message is a data of Multimedia Message Service (MMS) protocol.

13. The telephone with ability to communicate through various networks of claim 1, wherein the signal switching unit is an integrated circuit chip.

14. The telephone with ability to communicate through various networks of claim 1, further comprising:
a display, coupled to the central processing unit, capable of displaying data stored in the specific user identity card.

15. The telephone with ability to communicate through various networks of claim 1, further comprising:
a memory, coupled to the central processing unit, capable of storing the message.

16. The telephone with ability to communicate through various networks of claim 1, further comprising:
a PSTN interface module, for enabling the telephone to transmit/receive the message through the public switched telephone network.
